(19) United States
(12) Patent Application Publication
(10) Pub. No.: US 2026/0063505 A1
(43) Pub. Date: Mar. 5, 2026

(54) FLAMMABLE FLUID DRAINAGE GROUND TESTING

(71) Applicant: Gulfstream Aerospace Corporation, Savannah, GA (US)

(72) Inventors: Mitch Townsend, Savannah, GA (US); John Mcafee, Savannah, GA (US); Nikolaus Moberly, Savannah, GA (US); Nathan Coffee, Savannah, GA (US); Bridget Collins, Savannah, GA (US); JoaoPaulo Silva, Savannah, GA (US); Randy Nengel, Savannah, GA (US)

(73) Assignee: Gulfstream Aerospace Corporation, Savannah, GA (US)

(21) Appl. No.: 18/817,961

(22) Filed: Aug. 28, 2024

(51) Int. Cl. G01M 7/02; G01M 3/32

(52) U.S. Cl. CPC G01M 7/025; G01M 3/3236

(57) ABSTRACT

Methods and apparatuses for performing ground-based flammable fluid drainage testing are provided. An apparatus for performing flammable fluid drainage testing on a test article includes a spine configured to receive a coupon; a first wall structure configured to engage the spine to form a first chamber; a second wall structure configured to engage the spine to form a second chamber opposite the first chamber; a nozzle device configured to spray a fluid into the first chamber and onto the coupon; a vacuum device configured to create a pressure differential between the first chamber and the second chamber; a leg mounting the spine to a base; and a shaker platform configured to apply an excitation input to the coupon.

### TECHNICAL FIELD

The technical field relates generally to flammable fluid drainage testing, and more particularly relates to an apparatus for performing flammable fluid drainage testing on a test article supported by the ground and to methods for performing such testing.

### BACKGROUND

Various authorities throughout the world have the responsibility for establishing and enforcing regulatory requirements for civil aviation. Such regulatory requirements include safety regulations on transport category airplanes that are quite extensive. Implementation and enforcement processes for civil aviation are considerably more intricate and involved than those imposed by other regulatory agencies on land-based and water-based transport vehicles.

Among the required tests for transport category airplanes are flammability tests. These tests apply to various components regarding their usage and sometimes the materials of which the components are made.

For example, a flammable fluid drainage test requires that cells or zones of an aircraft are sufficiently sealed from adjacent zones such that fluid, such as flammable fluid cannot flow between zones. In other words, testing ensures that a flammable fluid is contained within a single zone in case of fire.

Therefore, certain testing requires establishing flight conditions around a test article while determining whether the test article is fluid tight, i.e., no fluid flows through the test article.

Such testing is typically performed during test flights, which can be prohibitively expensive.

Accordingly, it is desirable to provide flammable fluid drainage testing apparatuses and methods that address one or more of the foregoing issues. Furthermore, other desirable features and characteristics of the various embodiments described herein will become apparent from the subsequent detailed description and the appended claims, taken in conjunction with the accompanying drawings and this background.

### SUMMARY

Various non-limiting embodiments of methods and apparatuses for performing flammable fluid drainage ground testing are provided herein.

In a first non-limiting embodiment, an apparatus for performing flammable fluid drainage testing on a test article includes a spine configured to receive a coupon; a first wall structure configured to engage the spine to form a first chamber; a second wall structure configured to engage the spine to form a second chamber opposite the first chamber; a nozzle device configured to spray a fluid into the first chamber and onto the coupon; a vacuum device configured to create a pressure differential between the first chamber and the second chamber; a leg mounting the spine to a base; and a shaker platform configured to apply an excitation input to the coupon.

In certain embodiments of the apparatus, the spine is rotatably mounted to the leg to allow the test article to be positioned at a desired plane relative to a ground surface.

In certain embodiments of the apparatus, the coupon includes or is configured to hold a test article undergoing a flammable fluid drainage test.

In certain embodiments of the apparatus, the second wall structure includes a transparent window for viewing the coupon.

In certain embodiments, the apparatus further includes a spacer structure located between the spine and the second wall structure.

In certain embodiments, the apparatus further includes a spacer structure located between the spine and the second wall structure, and the spacer structure is formed with a curved surface to accommodate a curved coupon.

In certain embodiments of the apparatus, the first wall structure is formed with a drain, and the apparatus further includes a recirculation tank for receiving the fluid from the drain; and a flow controller for directing the fluid from the recirculation tank through the nozzle device.

In certain embodiments, the apparatus further includes a sensor located in the first chamber to monitor pressure.

In another non-limiting embodiment, a method for performing a flammable fluid drainage test includes fixing a test article to a spine; engaging a first wall structure to a spine to form a first chamber, wherein a fluid-side of the test article is in fluid communication with the first chamber; engaging a second wall structure to the spine to form a second chamber opposite the first chamber, wherein a pressure-side of the test article is in fluid communication with the second chamber; spraying a fluid into the first chamber and onto the test article; changing a pressure in the second chamber to create a pressure differential across the test article; and monitoring the test article to determine whether the fluid leaks through the test article to the second chamber.

In certain embodiments, the method further includes applying an excitation input to the test article with a shaker device.

In certain embodiments, the method further includes rotating the spine about a horizontal axis to position the test article at a desired plane.

In certain embodiments of the method, the test article is curved and the method further includes locating a curved spacer between the test article and the spine.

In certain embodiments, the method further includes monitoring pressure with a sensor in the second chamber.

In certain embodiments of the method, the test article is an aircraft component.

In another non-limiting embodiment, a method for performing a flammable fluid drainage test includes supporting a test article on a spine; forming a first chamber on a first side of the test article; forming a second chamber on a second side of the test article; spraying a fluid in the first chamber onto the first side of the test article; applying a vacuum in the second chamber and on the second side of the test article; and monitoring the second side of the test article to determine whether fluid leaks from the first side to the second side.

In certain embodiments, the method further includes mounting the spine to a shaker device; and applying an excitation input to the test article with the shaker device.

In certain embodiments, the method further includes rotatably mounted the spine to two legs; and rotating the spine to position the test article at a desired plane during testing.

In certain embodiments, the method further includes adjusting pressure in the second chamber during the flammable fluid drainage test.

In certain embodiments, the method further includes monitoring pressure with a sensor in the second chamber.

In certain embodiments, the method further includes recycling the fluid from the first chamber to be sprayed again onto the first side of the test article.

Embodiments herein provided for multiple test point combinations of pressure, vibration, and flow rate while performing a test.

### BRIEF DESCRIPTION OF THE DRAWINGS

The various embodiments will hereinafter be described in conjunction with the following drawing figures, wherein like numerals denote like elements, and wherein:

FIG. 1 is an exploded perspective view illustrating a flammable fluid drainage ground testing apparatus in accordance with an exemplary embodiment;

FIG. 2 is a non-exploded perspective view of the testing apparatus 100 of FIG. 1 in accordance with an exemplary embodiment;

FIG. 3 is a non-exploded perspective view of the testing apparatus 100 of FIGS. 1 and 2, after the spine is rotated about the rotation axis in accordance with an exemplary embodiment;

FIG. 4 is a schematic view of a testing apparatus in accordance with an exemplary embodiment; and

FIG. 5 is a schematic view of an embodiment of a testing apparatus for use with a curved test article in accordance with an exemplary embodiment.

### DETAILED DESCRIPTION

The following Detailed Description is merely exemplary in nature and is not intended to limit the various embodiments or the application and uses thereof. Furthermore, there is no intention to be bound by any theory presented in the preceding background or the following detailed description.

The exemplary embodiments taught herein are for use with panels or other components of vehicles, for example, an aircraft or the like.

Exemplary embodiments provides a flammable fluid drainage (FFD) ground testing apparatus and method. By performing the flammable fluid drainage on the ground, rather than during test flights, costs are reduced and allow for rapid response design changes to drive to an on aircraft configuration. For example, testing may be substantially completed on the ground such that any fluids leaks that are located may be fixed through the additional of sealant or through design changes. Then a single test flight may be performed to confirm that the ground test detected all leaks.

An exemplary apparatus receives coupons that mimic areas of flammable fluid drainage concern. Further, the exemplary apparatus allows for fluid to be sprayed on one side of the coupon while vacuum pressure is applied on the other. The exemplary apparatus also allows for vibration application. Also, coupon orientation relative to the vibration plane and level may be selected and obtained. Pressures and fluid flow rates may be controlled and all data may be monitored and recorded. The exemplary apparatus allows for viewing on both sides of the coupon during testing.

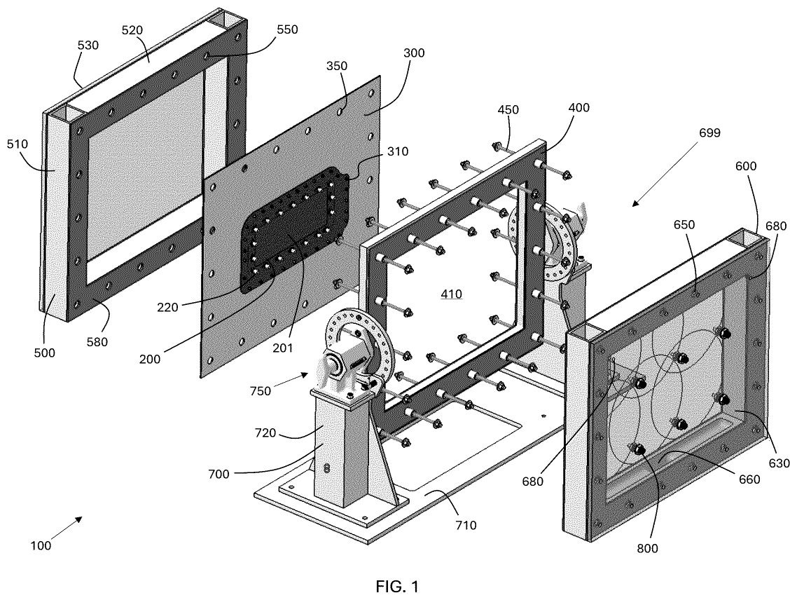

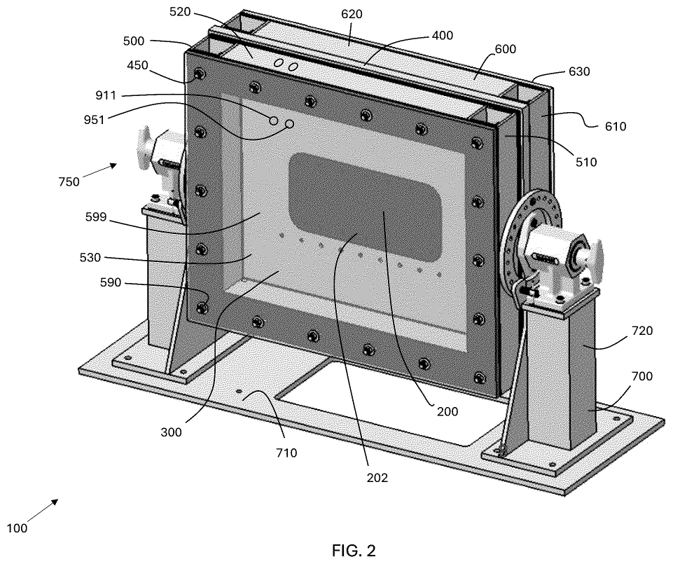

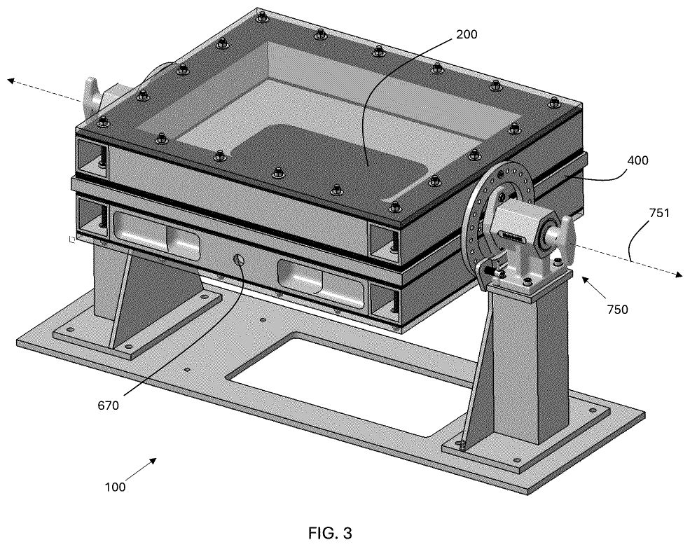

FIG. 1 is an exploded perspective view of a testing apparatus 100. FIG. 2 is a non-exploded perspective view of the testing apparatus 100 of FIG. 1. FIG. 3 is a non-exploded perspective view of the testing apparatus 100 of FIGS. 1 and 2, after the spine is rotated about the rotation axis.

Cross-referencing FIGS. 1-3, the testing apparatus 100 is configured to receive a test article 200. The test article 200 may be a “full stack up” element including a plurality of components that are interconnected. For example, the test article 200 may include all components as arranged in a region of an aircraft. The test article may be substantially planar and relatively thin, or may include features that extend outward from the plane of the test article.

As shown, the test article 200 is received in a coupon 300. For example, the coupon 300 may be formed with an opening 310 that is dimensioned to receive the test article 200. The test article 200 may overlap with the coupon 300 around the opening 310 and may be fixed to the coupon 300 with fasteners 220. With this arrangement neither a first side 201 nor a second side 202 of the test article 200 is covered by the coupon 300. Further, the test article 200 may be mounted to subplates to fit into any of the standard apparatus sizes.

As further shown in FIGS. 1-3, the coupon 300 may be received on and fixed to a spine 400. As shown, the spine 400 is also formed with a central opening 410. The first side 201 of the test article 200 is fitted within the central opening 410. To connect the coupon 300 and spine 400, the spine 400 includes projections 450, such as bolts, that are received within and pass through bores or holes 350 in the coupon 300. A gasket may be located between the coupon 300 and the spine 400.

Further, two wall structures 500 and 600 are provided to encase the test article 200 within the apparatus 100.

For example, wall structure 500 connects to the coupon 300, and may compress the coupon 300 between the spine 400 and the wall structure 500. As shown, the wall structure 500 includes vertical beams 510 that are interconnected by lateral beams 520. Further, an outer transparent window 530 is sealed to the beams 510 and 520. A gasket 580 may be located between the wall structure 500 and the coupon 300. As shown, the gasket 580 and wall structure 500 include bores or holes 550 to receive the projections 450 for connection to the spine 400. Fasteners 590, such as nuts, may be tightened to enclose a fluid-tight chamber 599 between the window 530 and the coupon 300 and test article 200 therein.

As shown, window 530 may be formed with a pressure data port 911 and a pressure application port 951. Alternatively, ports 911 and 951 may be formed in the lateral beam 520 as indicated or in other structure bounding chamber 599.

Further, wall structure 600 connects to the spine 400. As shown, the wall structure 600 includes vertical beams 610 that are interconnected by lateral beams 620. Further, an outer transparent window 630 is sealed to the beams 610 and 620. A gasket may be located between the wall structure 600 and the spine 400. As shown, the wall structure 600 include bores or holes 650 to receive the projections 450 for connection to the spine 400. Fasteners, such as nuts, may be tightened to enclose a chamber 699 between the window 630 and the coupon 300 and test article 200 therein. Window 630 may be formed with vents 680 to ensure ambient pressure in chamber 699.

Nozzle devices 800 are provided in a desired arrangement on and through window 630 and are configured to spray fluid onto the test article 200 within the chamber 699. Also, the lower lateral beam 620 of wall structure 600 may be formed with a pocket 660 that leads to a drain 670 for removing fluid from the chamber 699.

As further shown, the spine 400 and/or wall structures 500 and 600 are supported by a frame 700. The frame 700 includes a base 710 and legs 720 that extend upwardly from the base 710. As shown, a rotary mount 750 is located at the upper end of each leg 720 and connects to the spine 400 and/or wall structures 500 and 600. As a result, the spine 400 and/or wall structures 500 and 600, and the test article 200 when mounted therein, may be positioned at any plane passing through the rotation axis 751 of the rotary mount 750. The rotary mount 750 may include a motor to rotate according to a program or upon demand from a controller or from a user. Further, the rotary mount 750 may lock at any desired angle to hold the connection without further rotation.

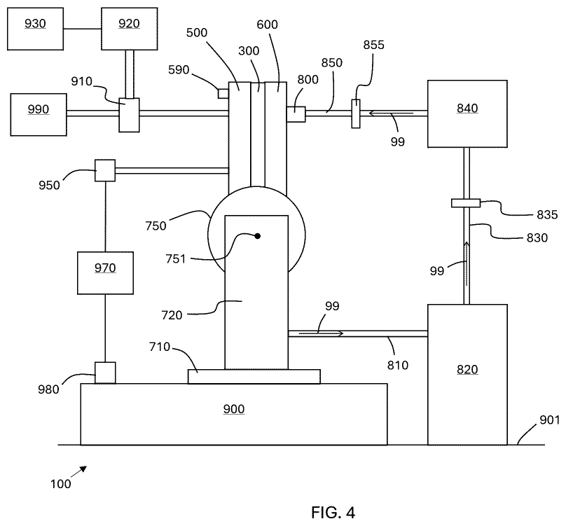

FIG. 4 further provides a schematic layout of the apparatus 100. As shown, in FIG. 4, the base 710 of the frame 700 is mounted on and to a shaker device 900, such as a shaker table or platform. The shaker device 900 may be mounted on or include wheels to provide for easy transport of the apparatus 100. As shown, the shaker device 900 rests on the ground surface 901. The shaker device 900 is configured to apply an excitation input to the test article 200. The shaker device 900 may shake and/or vibrate, producing the excitation input that is communicated to the test article 200.

In the apparatus 100 of FIG. 4, a tube 810 or hose is provided and removes fluid 99 from the drain 670 in the wall structure 600. The tube 810 carries fluid 99 to a recirculation tank 820. Further, a flow controller 840 removes fluid 99 from the recirculation tank 820 through a tube 830 or hose. A pump 835 may be provided to pump fluid 99 through tube 830. Also, the flow controller 840 directs the fluid 99 through tube 850 or hose to nozzle devices 800. The nozzle devices 800 are configured to spray the fluid 99 onto the test article 200 held within chamber 699. A flow meter 855 may be provided on tube 850 to monitor the flow rate of the fluid 99.

As further shown in FIG. 4, a pressure device 990 is provided in fluid communication with the chamber 599. The pressure device 990 may be a vacuum device configured to reduce the pressure within the chamber 599. As a result, a pressure differential may be applied across the test article 200.

As shown in FIG. 4, a vacuum booster or regulator 910 may be connected between the pressure device 990 and the chamber 599, specifically through port 911 shown in FIG. 2. As further shown in FIG. 4, a voltage to pressure transducer or E/P transducer 920 may be operatively connected to the regulator 910. Also, a potentiometer 930 may be operatively connected to the E/P transducer 920.

As arranged, the potentiometer 930 may be used to control the vacuum pressure applied from pressure device 990 to the chamber 599. Specifically, the potentiometer 930 may adjust a voltage or signal input to the E/P transducer 920, thereby varying the output pressure from the E/P transducer 920 to the regulator 910 and the regulated pressure applied to the chamber 599.

As further illustrated in FIG. 4, the apparatus 100 may include a pressure sensor, such as a pressure transducer 950, in communication with the chamber 599, specifically through port 951 shown in FIG. 2. In FIG. 4, pressure transducer 950 may be provided to convert the chamber pressure to an electric pressure signal. As shown, the pressure transducer 950 is electrically connected to a data acquisition system 970, and may communicate the electric pressure signal to the data acquisition system 970. Further, a transducer 980 may be located on the frame 700, such as on the base 710 of the frame 700. Transducer 980 may be an accelerometer configured to generate an electrical signal output from a mechanical acceleration input, e.g., the excitation input from the shaker device 900. As shown the transducer 980 is electrically connected to the data acquisition system 970, and may communicate the electric signal output to the data acquisition system 970. As arranged, the data acquisition system 970 may monitor the pressure in the chamber 599 and the mechanical excitation input to the chamber 599.

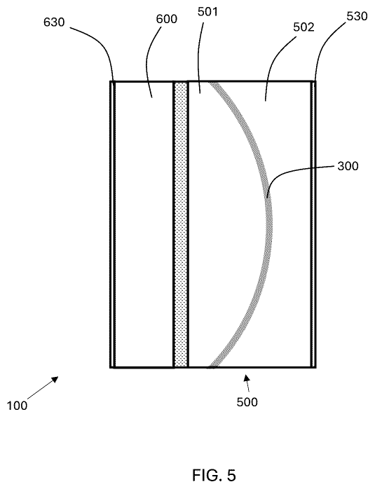

In FIG. 5, the apparatus 100 is provided with structures for adaptation for use with curved test articles. As shown, in FIG. 5, the coupon 300 is curved, such that the coupon 300 has a same curvature as the test article. As shown, the wall structure 500 is provided with a first spacer 501 having an outer surface matching the curvature of the coupon 300. The first spacer 501 is located between the spine 400 and the coupon 300. Further, the wall structure 500 is provided with a second spacer 502 having an inner surface matching the curvature of the coupon 300. The second spacer 502 is located between the coupon 300 and the window 530. Thus, the wall structure 500 may enclose a chamber 599 around a curved test article.

Cross-referencing FIGS. 1-5, it may be seen that the apparatus 100 may be designed to perform a test on a test article of any desired dimensions and shape. Further, the apparatus 100 may be operated to apply a desired flow amount of fluid onto the test article 200 for a desired duration and according to a pattern that may vary; to apply a desired pressure differential or pressure differentials across the test article 200; to apply a desired acceleration from the shaker device to the test article 200; and to position the test article 200 at a desired plane or planes of rotation during the testing.

In an exemplary embodiment, a method includes forming the coupon 300 as the test article 200 or with the test article 200. The coupon 300 may be formed with a universal perimeter for connection to the spine 400.

Based on the test article, a depth for testing the test article is determined. In the method, the chambers 599 and/or 699 are prepared by assembling the wall structures 500 and 600 with sufficient depth to hold the test article.

Thus, after assembling the appropriate apparatus 100 from a coupon 300, wall structure 500, and wall structure 600 of desired dimension appropriate for use with the test article, the apparatus 100 is mounted to the rotary mount 750 resting on the frame 700 located on the shaker device 900. Further, the flow controller 840 and pressure device 990 are connected to the respective chambers 699 and 599.

Then a testing procedure may be selected. For example, a start time, flow rate, and flow duration for spraying fluid onto the test article 200 may be selected. Various pressure differentials may be applied during testing. For example, a first differential pressure may be applied at a desired start time and for a desired duration, and a second differential pressure may be applied at a desired start time and for a desired duration. Any suitable levels of differential pressure may be used. Also, the shaker device 900 may apply a desired excitation input beginning at a desired start time for a desired duration. Further, the rotary device 750 may rotate the test article 200 to a desired plane, and then to a second desired plane, and to any number of successive desired planes, at scheduled times during the test process.

The method includes video recording, or viewing, the chamber 599 and the test article 200 therein through window 530 to determine where a fluid leak occurs in the test article. Because the testing procedure occurs on the ground, the test article may be immediately revised, such as by the addition of sealant in selected areas, or even a re-design of components. Iterations of the testing and revisions may be continued to be performed until the test article passes the testing procedure by not leaking. Then, a test flight may be performed to confirm that all test articles do not leak under flight conditions.

As described herein, the testing apparatus may be used to mimic any condition that the test article may undergo during a flight. Thus, the testing apparatus provides for inexpensively re-creating flight conditions to allow for flammable fluid drainage testing of a test article.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. An apparatus for performing flammable fluid drainage testing on a test article, the apparatus comprising:
a spine configured to receive a coupon;
a first wall structure configured to engage the spine to form a first chamber;
a second wall structure configured to engage the spine to form a second chamber opposite the first chamber;
a nozzle device configured to spray a fluid into the first chamber and onto the coupon;
a vacuum device configured to create a pressure differential between the first chamber and the second chamber;
a leg mounting the spine to a base; and
a shaker platform configured to apply an excitation input to the coupon.

2. The apparatus of claim 1, wherein the spine is rotatably mounted to the leg to allow the test article to be positioned at a desired plane relative to a ground surface.

3. The apparatus of claim 1, wherein the coupon comprises or is configured to hold a test article undergoing a flammable fluid drainage test.

4. The apparatus of claim 1, wherein the second wall structure includes a transparent window for viewing the coupon.

5. The apparatus of claim 1, further comprising a spacer structure located between the spine and the second wall structure.

6. The apparatus of claim 1, further comprising a spacer structure located between the spine and the second wall structure, wherein the spacer structure is formed with a curved surface to accommodate a curved coupon.

7. The apparatus of claim 1, wherein the first wall structure is formed with a drain, and wherein the apparatus further comprises:
a recirculation tank for receiving the fluid from the drain; and
a flow controller for directing the fluid from the recirculation tank through the nozzle device.

8. The apparatus of claim 1, further comprising a sensor located in the first chamber to monitor pressure.

9. A method for performing a flammable fluid drainage test, the method comprising:
fixing a test article to a spine;
engaging a first wall structure to a spine to form a first chamber, wherein a fluid-side of the test article is in fluid communication with the first chamber;
engaging a second wall structure to the spine to form a second chamber opposite the first chamber, wherein a pressure-side of the test article is in fluid communication with the second chamber;
spraying a fluid into the first chamber and onto the test article;
changing a pressure in the second chamber to create a pressure differential across the test article; and
monitoring the test article to determine whether the fluid leaks through the test article to the second chamber.

10. The method of claim 9, further comprising applying an excitation input to the test article with a shaker device.

11. The method of claim 9, further comprising rotating the spine about a horizontal axis to position the test article at a desired plane.

12. The method of claim 9 wherein the test article is curved, and wherein the method further comprises locating a curved spacer between the test article and the spine.

13. The method of claim 9, further comprising monitoring pressure with a sensor in the second chamber.

14. The method of claim 9, wherein the test article is an aircraft component.

15. A method for performing a flammable fluid drainage test, the method comprising:
supporting a test article on a spine;
forming a first chamber on a first side of the test article;
forming a second chamber on a second side of the test article;
spraying a fluid in the first chamber onto the first side of the test article;
applying a vacuum in the second chamber and on the second side of the test article; and
monitoring the second side of the test article to determine whether fluid leaks from the first side to the second side.

16. The method of claim 15, further comprising:
mounting the spine to a shaker device; and
applying an excitation input to the test article with the shaker device.

17. The method of claim 15, further comprising:
rotatably mounted the spine to two legs; and
rotating the spine to position the test article at a desired plane during testing.

18. The method of claim 15, further comprising adjusting pressure in the second chamber during the flammable fluid drainage test.

19. The method of claim 15, further comprising monitoring pressure with a sensor in the second chamber.

20. The method of claim 15, further comprising recycling the fluid from the first chamber to be sprayed again onto the first side of the test article.
